(19) United States
(12) Patent Application Publication
(10) Pub. No.: US 2011/0131121 A1
(43) Pub. Date: Jun. 2, 2011

(54) Refinancing Program for an Underwater Loan

(75) Inventors: Theresa Lynn Hagman, Moorpark, CA (US); Jason Lawrence Thalken, Tarzana, CA (US); Thomas Adrian, Studio City, CA (US)

(73) Assignee: Bank of America Corporation, Charlotte, NC (US)

(21) Appl. No.: 12/627,832

(22) Filed: Nov. 30, 2009

(51) Int. Cl. G06Q 40/00

(52) U.S. Cl. 705/35

(57) ABSTRACT

A refinancing program for an underwater loan is disclosed. In particular embodiments, a method for refinancing a loan includes determining an original loan value, wherein the original loan value is associated with an original loan secured by a property having a current property value that is less than the original loan value. The method also includes calculating, with a processor, a conforming loan value based, at least in part, on the current property value, wherein the conforming loan value is associated with a conforming loan and the conforming loan value is less than the current property value. The method also includes calculating a shared appreciation mortgage (SAM) loan value based on a numerical difference between the conforming loan value and the original loan value.

### TECHNICAL FIELD OF THE INVENTION

The present invention relates generally to real estate financing, and more specifically to a refinancing program for an underwater loan.

### BACKGROUND OF THE INVENTION

Declining real estate values create numerous problems for lenders and borrowers alike. The structure of a loan used to purchase real estate may exacerbate the problems. Borrowers in payment option loans and interest-only loans face steep increases to their monthly payments when their loans begin to amortize and principle payments become due. Borrowers with adjustable rate mortgages also face steep increases to their monthly payments when their loans are recast. These events may cause payment shock to borrowers, which increases the likelihood of foreclosure. When a borrower experiences payment shocks in addition to negative amortization, the likelihood of foreclosure is even greater. These borrowers would typically refinance their loans to receive a lower monthly payment. However, these borrowers are unable to refinance because, in many cases, they cannot afford an amortizing monthly payment on their current loan balance. As a result of falling real estate values and negative amortization, many borrowers now owe more money than the current value of the real estate securing the loan. Broader economic conditions, including likely high unemployment and underemployment into the indefinite future, exacerbate these trends.

### SUMMARY OF THE INVENTION

In accordance with the present invention, the disadvantages and problems associated with prior real estate financing systems have been substantially reduced or eliminated.

In accordance with one embodiment of the present disclosure, a method for refinancing a loan includes determining an original loan value, wherein the original loan value is associated with an original loan secured by a property having a current property value that is less than the original loan value. The method also includes calculating, with a processor, a conforming loan value based, at least in part, on the current property value, wherein the conforming loan value is associated with a conforming loan and the conforming loan value is less than the current property value. The method also includes calculating a shared appreciation mortgage (SAM) loan value based on a numerical difference between the conforming loan value and the original loan value, wherein the SAM loan value is associated with a SAM loan, and payments are not due on the SAM loan unless a title associated with the property is conveyed and the SAM loan value becomes due upon conveyance of the title associated with the property.

In accordance with another embodiment of the present disclosure, a system for refinancing a loan includes a loan calculation server operable to determine an original loan value, wherein the original loan value is associated with an original loan secured by a property having a current property value that is less than the original loan value. The loan calculation server is also operable to calculate a conforming loan value based, at least in part, on the current property value, wherein the conforming loan value is associated with a conforming loan and the conforming loan value is less than the current property value. The loan calculation server is also operable to calculate a shared appreciation mortgage (SAM) loan value based on a numerical difference between the conforming loan value and the original loan value, wherein the SAM loan value is associated with a SAM loan, and payments are not due on the SAM loan unless a title associated with the property is conveyed and the SAM loan value becomes due upon conveyance of the title associated with the property. The system also includes a loan officer computer operable to transmit, to the loan officer computer, a lender portion value associated with a lender portion of the SAM loan value and a borrower portion value associated with the lender portion of the SAM loan value, receive the conforming loan value and the SAM loan value from the loan calculation server, and display the conforming loan value and the SAM loan value on a graphical user interface associated with the loan officer computer.

In accordance with yet another embodiment of the present disclosure, an apparatus for refinancing a loan includes the apparatus operable to determine an original loan value, wherein the original loan value is associated with an original loan secured by a property having a current property value that is less than the original loan value. The apparatus is further operable to calculate a conforming loan value based, at least in part, on the current property value, wherein the conforming loan value is associated with a conforming loan and the conforming loan value is less than the current property value. The apparatus is also operable to calculate a shared appreciation mortgage (SAM) loan value based on a numerical difference between the conforming loan value and the original loan value, wherein the SAM loan value is associated with a SAM loan, and payments are not due on the SAM loan unless a title associated with the property is conveyed and the SAM loan value becomes due upon conveyance of the title associated with the property.

In accordance with yet another embodiment of the present disclosure, a computer readable storage medium comprises logic, the logic operable, when executed on a processor, to determine an original loan value, wherein the original loan value is associated with an original loan secured by a property having a current property value that is less than the original loan value. The logic is also operable to calculate a conforming loan value based, at least in part, on the current property value, wherein the conforming loan value is associated with a conforming loan and the conforming loan value is less than the current property value. The logic is also operable to calculate a shared appreciation mortgage (SAM) loan value based on a numerical difference between the conforming loan value and the original loan value, wherein the SAM loan value is associated with a SAM loan, and payments are not due on the SAM loan unless a title associated with the property is conveyed and the SAM loan value becomes due upon conveyance of the title associated with the property.

Technical advantages of certain aspects of the present disclosure include calculating a shared equity portion and a conforming loan portion to facilitate the refinancing of an underwater loan. In some embodiments, a lending institution uses public funds as part of the financing of the shared equity portion, thus facilitating the refinancing of underwater loans that a lending institution would otherwise not refinance. Calculating a shared equity portion and a conforming loan portion may be automated by the use of information included in loan profiles, borrower profiles and/or property profiles. Moreover, embodiments of the present disclosure may use available market data regarding the estimated future property values to calculate a time at which a borrower's loan will no longer be underwater. In some embodiments, an interface to refinancing system may be used by a loan officer to dynamically and automatically update various values associated with the refinancing of an underwater loan. In particular, a loan officer or other user may input one or more variables that change the relative values associated with the conforming loan portion and the shared equity portion. Aspects of the present disclosure further include mitigating or eliminating payment shock caused by recast interest-only or payment option loans. Particular embodiments enable a borrower to refinance, by obtaining a conforming loan and a shared equity mortgage, an underwater current loan and obtain affordable payments. Thus, particular embodiments, of the present disclosure may enable borrowers to prevent foreclosure of properties that have experienced declines in property values or have associated loans that have recast into higher monthly payments. Other technical advantages of the present disclosure will be readily apparent to one skilled in the art from the following figures, description, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description taken in conjunction with the accompanying drawings, in which:

FIG. 1 illustrates a refinancing system that facilitates the refinancing of an underwater loan in accordance with particular embodiments of the present disclosure;

FIG. 2 illustrates the account server illustrated in FIG. 1 in more detail, including aspects of the present disclosure;

FIG. 3 illustrates the loan calculation server illustrated in FIG. 1 in more detail, including aspects of the present disclosure;

FIG. 4 illustrates a graphical user interface used in facilitating the refinancing of an underwater loan in accordance with particular embodiments of the present disclosure; and

FIG. 5 is a flow chart illustrating a particular operation of the refinancing system of FIG. 1 in accordance with particular embodiments of the present disclosure.

### DETAILED DESCRIPTION OF THE INVENTION

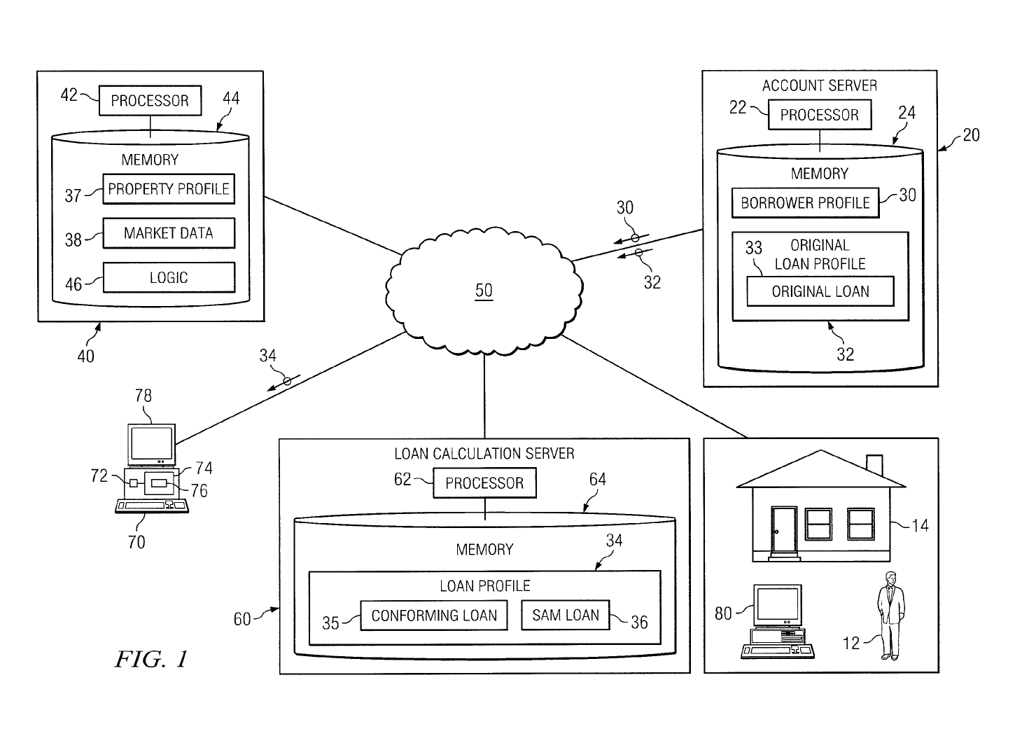

FIG. 1 illustrates an underwater refinancing system 10, according to certain embodiments. Refinancing system 10 may comprise borrower 12, property 14, account server 20, market data server 40, and loan calculation server 60. Account server 20, market data server 40, and loan calculation server 60 may be communicatively coupled by network 50. Refinancing system 10 is generally operable to facilitate refinancing of original loan 33 associated with property 14, the value of which is currently less than a current value of original loan 33. To refinance original loan 33 refinancing system 10 calculates a conforming loan, a shared appreciation mortgage (SAM) loan based on a current value of property 14 and a current value of original loan 33.

In general, refinancing system 10 calculates a structure for conforming loan 35 and SAM loan 36 in order to refinance original loan 33. The value of conforming loan 35 may be based, at least in part, on the current value of property 14. The value of SAM loan 36 may be based on a difference between a current value of original loan 33 and a value of conforming loan 35. In particular embodiments, SAM loan 36 represents a portion of the available equity in property 14. The available equity includes a difference between a current value of property 14 and a current value of conforming loan 35 at a particular point in time.

SAM loan 36 includes a lender equity reserve. In particular embodiments, the lender equity reserve is a difference between a current value of property 14 and a value of conforming loan 35 at the time original loan 35 is refinanced. The lender that provides funds for and/or finances SAM loan 36 is guaranteed a return of the amount of the lender equity reserve in the event borrower 12 sells, transfers, or otherwise conveys property 14 subsequent to the refinancing of original loan 35. SAM loan 36 also includes a lender portion of equity appreciation in property 14 subsequent to the refinancing of original loan 35. In particular embodiments, the lender portion of equity appreciation is limited to the lender equity reserve, plus any accumulated interest on SAM loan 36. In some embodiments, conforming loan 35 represents an amortized conforming loan payable in regular installments over a predetermined number of years. In particular embodiments, SAM loan 36 is not due and/or payable until borrower 12 sells, transfers, or otherwise conveys title to property 14. Additionally, SAM loan 36 may accrue interest at a predetermined rate until SAM loan 36 becomes due.

For purposes of this disclosure, original loan 33 refers to a loan used by borrower 12 to purchase property 14. In particular embodiments, original loan 33 includes one or more attributes, including, but not limited to, a fixed or adjustable rate interest rate, a term of years over which original loan 33 is payable, an amount of principle and/or interest due per payment, an original loan value, and/or any other appropriate attributes. Original loan 33 is secured by a mortgage on property 14.

Conforming loan 35 refers to a fixed- or variable-rate amortized loan in which the loan value is less than any suitable predetermined amount. In a particular embodiment, the predetermined amount is set in accordance with an appropriate regulatory standard. For example, the predetermined amount may be $417,000 in accordance with federal and/or state mortgage regulations. A borrower of conforming loan 35 makes payments on conforming loan 35 according to a predetermined schedule. An underwater loan refers to a loan in which the value of the collateral securing the loan has fallen below a current value of the loan. A current value of the loan refers to an amount of money borrowed plus any accumulated interested, minus any principal or interest payments paid.

In particular embodiments, refinancing system 10 receives borrower profile 30 and property profile 37 associated with original loan 33. Using borrower profile 30 and property profile 37, refinancing system 10 calculates a conforming loan value associated with conforming loan 35 and a SAM value associated with SAM loan 36. In particular embodiments, original loan 33 may be underwater. For example, borrower 12 may borrow $175,000 from a financial institution, and use $25,000 as a cash down payment to purchase property 14 valued at the time of purchase at $200,000. Property 14 may be used as collateral for the borrowed amounts (in this case, $175,000). If the value of property 14 subsequently falls below a current value of original loan 33 (e.g., in this case, $175,000 minus any principal and/or interest payments made, plus any accumulated interest), original loan 33 and/or property 14 may be characterized as underwater. In particular embodiments, the value of the collateral may fall below a certain predetermined percentage of the current value of original loan 33 before the loan may be characterized as underwater.

Borrower profile 30 includes information associated with borrower 12 who borrows an amount of money represented by original loan 33. Borrower profile 30 may include information associated with borrower 12 and/or original loan 33, including, but not limited, to borrower's 12 income history, credit score, credit history, address information, the value of original loan 33 at the time original loan 33 was originated, an interest rate and/or interest rates associated with original loan 33, a down payment provided by borrower 12 in connection with original loan 33, and/or any other relevant information used by a financial institute to originate, buy, sell, transfer, and/or otherwise process original loan 33.

Property profile 37 includes information about property 14 purchased by borrower 12 and used to secure original loan 33. Property profile 37 may include the value of property 14 at the time borrower 12 purchased property 14, one or more values of property 14 subsequent to borrower's 12 purchase of property 14, a current value of property 14, an address of property 14, a description of property 14, and/or any other relevant values, characteristics, descriptions and/or information associated with property 14 used by a financial institution to originate, buy, sell, and/or otherwise process original loan 33.

In some embodiments, refinancing system 10 calculates one or more loan values associated with conforming loan 35 and SAM loan 36 based on the current value of original loan 33 and the current value of property 14. SAM loan 36 may additionally or alternatively be referred to as a “silent second,” or “shared equity loan.” As discussed above, the current value of original loan 33 refers to the amount originally borrowed to purchase property 14, plus any accumulated interest, minus any principal and/or interest payments made. In particular embodiments, due to accumulated interest, the current value of original loan 33 may be higher than the value of original loan 33 at the time of the purchase of property 14. The current value of property 14 refers to any estimate, appraisal, and/or valuation done within a predetermined time prior to or contemporaneously with a refinancing of original loan 33. A predetermined time period represents, for example, thirty (30) days, one hundred and eighty (180) days, one year, and/or any other appropriate time period. Property 14 may be valued by a county appraisal district, a tax appraisal district, and/or an independent appraiser. Additionally, property 14 may be valued in accordance with general national, state, or local market trends. Thus, the current value of property 14 refers to any such valuation, appraisal, or estimation done by a relevant appraising entity or person within a predetermined time period.

In some embodiments, refinancing system 10 calculates a conforming loan value associated with conforming loan 35 based, at least in part, on the current value of property 14. The conforming loan value may be calculated as a predetermined percentage of the current value of property 14. For example, the conforming loan value may be calculated as 80% of the value of current value of property 14, as 90% of the current value of property 14, as 97.5% of the current value of property 14 and/or any other particular percentage of the current value of property 14. In some embodiments, the predetermined percentage used to calculate the conforming loan value may depend on lending criteria of the lending institution providing the funds for conforming loan 35. In some embodiments, loan officer 16 may input and/or change a predetermined percentage of the current value of property 14 at loan officer computer 70 to adjust a payment amount associated with conforming loan 35. IN some embodiments, borrower 12 may be able to afford a higher payment associated with conforming loan 35. In some embodiments, borrower 12 may need the lowest possible payment. Thus, loan officer 16 may adjust the percentage of the current value of property 14 as one manner of customizing refinancing system 10 to the particular needs of borrower 12.

In some embodiments, SAM loan 36 represents portion of the available equity in property 14. SAM loan 36 includes a lender equity reserve and a lender portion of equity appreciation. As discussed above, a lender equity reserve represents an undivided portion of equity in property 14, calculated as the difference between a value of property 14 and a value of conforming loan 35 at the time original loan 33 is refinanced. The lender equity reserve is payable to a lender financing SAM loan 36 upon conveyance of property 14. Moreover, in some embodiments, equity in property 14 appreciates over time (due to a rising property value of property 14 and/or principle payments applied to conforming loan 35). Refinancing system 10 may calculate a lender portion of the equity appreciation and a borrower portion of the equity appreciation. Refinancing system 10 may calculate a lender portion value associated with the lender portion and a borrower portion value associated with the borrower portion. To calculate a SAM loan value associated with SAM loan 36, refinancing system 10 may calculate a difference between the current value of original loan 33 and the current value of conforming loan 35. In general, the borrower portion value and the lender portion value may each comprise a different relative portion of the equity appreciation. For example, in some embodiments the lender portion and the borrower portion each represent 50% of the equity appreciation. In other embodiments, the lender portion represents 45%, and the borrower portion represents 55% of the equity appreciation. In particular embodiments, the lender portion of equity appreciation may be limited by the amount of interest accrued on SAM loan 36. The different respective proportions that the lender portion and the borrower portion represent may depend on an interest rate associated with SAM loan 36. For example, borrower 12 may select a lower interest rate on SAM loan 36 in exchange for a lower borrower portion. Conversely, borrower 12 may select a higher interest rate on the SAM loan in exchange for a higher borrower portion. Additionally, in particular embodiments, the borrower portion and/or the lender portion may include any closing costs, mortgage insurance premium, and/or other fees or costs associated with refinancing original loan 33.

In some embodiments, conforming loan 35 may be amortized over a predetermined number of years. Additionally, payments may be due from borrower 12 in periodic installments for a predetermined number of months or years. In particular embodiments, conforming loan 35 may be amortized over thirty (30) years or 360 months at a fixed or variable interest rate. Payments may be due monthly, bi-monthly, or accordingly any other appropriate schedule. In general, conforming loan 35 may be amortized over any appropriate number of years at any appropriate interest rate.

SAM loan 36 may be structured in various ways. In particular embodiments, SAM loan 36 may be structured as shared equity between borrower 12 and a lending institution, such as, for example, the United States government. As such, no payments are due from borrower 12 on SAM loan 36 until borrower 12 transfers title to property 14 subsequent to a refinancing of original loan 33. Upon such transfer of title, amounts owed by borrower 12, including amounts owed on conforming loan 35 and SAM loan 36, may become immediately due and payable. In some embodiments, SAM loan 36 may be structured as a deferred, interest-bearing amortized loan. For example, SAM loan 36 may be structured such that no payments are due for a predetermined time period, such as, for example, thirty-six (36) months. Subsequent to the predetermined time period, borrower 12 begins making payments on SAM loan 36.

As discussed above, property 14 represents real estate purchased by borrower 12 and serving as collateral for original loan 33. Property 14 may represent a single family home, multi-tenant building, a condominium unit, a townhome, undeveloped land, commercial real estate, a mobile home, or any other developed or undeveloped real estate. Borrower 12 may use funds from original loan 33 to purchase property 14. Additionally, a lending institution may secure original loan 33 with a mortgage on property 14.

Account server 20 stores borrower profile 30 and original loan profile 32, and communicatively couples to loan calculation server 60 over network 50. According to particular embodiments of refinancing system 10, account server 20 may transmit borrower profile 30 and/or original loan profile 32 to loan calculation server 60. Borrower profile 30 may be transmitted to loan calculation server 60 in response to a request for information associated with borrower 12 from loan calculation server 60. Account server 30 may be maintained and/or operated by a bank, mortgage broker, investment banking firm, and/or other suitable financial services company. In some embodiments, account server 20 may be maintained and/or operated by a mortgage lender that originated original loan 33. Account server 20 stores borrower profile 30 and original loan profile 32 on memory 24. Memory 24 is communicatively coupled to processor 22. Processor 22 is generally operable to receive requests for information associated with borrower 12, information associated with original loan 33 generate, store borrower profile 30 and/or original loan profile 32 in memory 24, retrieve borrower profile 30 and/or original loan profile 32 from memory 24, and/or transmit borrower profile 30 and/or original loan profile 32 to loan calculation server 60.

Original loan profile 32 represents information pertaining to original loan 33. In some embodiments, original loan profile 32 may include an amount borrowed to purchase property 14, an amortization schedule associated with original loan 33, an interest rate(s) associated with original loan 33, a current value of original loan 33 (including the value of original loan 33 when it was originated, minus any principal and/or interest payments made, plus any accumulated interest), information indicating whether original loan 33 is performing or is in default, and/or any other relevant information associated with original loan 33. In some embodiments, account server 20 may periodically update original loan profile 32 and/or borrower profile 30 stored in memory 24.

Market data server 40 stores market data 38, which includes information associated with property values. Market data 38 may include information representing national, state-level, or local-level property values. Market data 38 includes data representing the value(s) of one or more particular properties. Market data server 40 may obtain valuation information from county appraisal districts, tax appraisal districts, market surveys, past sales, real estate comparables, rental rates, multiple listing services, and/or any other relevant property valuation information source. For particular properties, market data server 40 may store one or more property profiles 37. Property profile 37 may include an address of a particular property, past and present ownership information, and/or information on any liens or encumbrances. Additionally, property profile 37 may include valuation information pertaining to a particular property, including past values, current values, and/or estimated future values. In some embodiments, market data server 40 may apply market data 38 to property profile 37. For example, based on property value information contained in market data 38, market data server 40 may update the value of a particular property in property profile 37 to reflect current pricing trends or property value information. In particular, based on market data 38, market data server 40 updates a property value of a particular property stored in property profile 37. In some embodiments, a property value stored in property profile 37 is updated on regular basis (such as, for example, monthly or yearly), or upon a conveyance of a particular property associated with property profile 37. In some embodiments of refinancing system 10, a particular property profile 37 may include property information for a plurality of properties. For example, property profile 37 may include data associated with property 14 and another property. In particular embodiments, market data server 40 transmits property profile 37 to loan calculation server 60 over network 50. Market data server 40 may be maintained by a mortgage broker, a bank, a real estate services firm, and/or any other suitable financial or real estate institution.

Market data server 40 may comprise any suitable combination of hardware and/or software implemented in one or more modules to provide the described functions and operations. In some embodiments, market data server 40 may comprise a general-purpose personal computer (PC), a Macintosh, a workstation, a Unix-based computer, a server computer, or any suitable processing device. In some embodiments, the functions and operations described above may be performed by a pool of multiple market data servers 40. A particular market data server 40 may comprise memory 44 and processor 42.

Memory 44 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. Although FIG. 1 illustrates memory 44 as internal to market data server 40, it should be understood that memory 44 may be internal or external to market data server 40, depending on particular implementations. Memory 44 may be separate from or integral to other memory devices to achieve any suitable arrangement of memory devices for use in refinancing system 10.

Memory 44 stores market data 38 and/or property profile 37. Memory 44 also stores logic 46. Logic 46 generally comprises rules, algorithms, code, tables, and/or other suitable instructions for storing and/or generating market data 38.

Memory 44 is communicatively coupled to processor 42. Processor 42 is generally operable to execute logic 46 to generate market data 38 and/or property profile 37, store market data 38 and/or property profile 37, and transmit market data 38 and/or property profile 37 to loan calculation server 60. Processor 42 comprises any suitable combination of hardware and software implemented in one or more modules to provide the described function or operation.

Loan calculation server 60 receives original loan profile 32, borrower profile 30, and property profile 37, and calculates a structure for conforming loan 35 and SAM loan 36 based on original loan profile 32, borrower profile 30, and/or property profile 37. Loan calculation server comprises memory 64 and processor 62. Loan calculation server 60 stores information associated with conforming loan 35 and SAM loan 36 in original loan profile 32 in memory 64. Processor 62 is communicatively coupled to memory 64. Processor 62 is generally operable to calculate a structure of conforming loan 35 and SAM loan 36 based on original loan profile 32, borrower profile 30, and/or property profile 37.

As discussed above, loan calculation server 60 may calculate a conforming loan value associated with conforming loan 35 and a SAM loan value associated with SAM loan 36 based on a property valuation indicated in property profile 37 and a current value of original loan 33. The conforming loan value may be based, at least in part, on the current value of property 14. As discussed above, the conforming loan value may be a predetermined percentage of the current value of property 14. Once loan calculation server 60 calculates a conforming loan value, loan calculation server 60 stores the conforming loan value in original loan profile 32.

The SAM loan value is based, at least in part, on a difference between a current value of original loan 33 and the calculated conforming loan value. As property 14 increases in value and/or principle is paid on conforming loan 33, the equity in property 14 appreciates. SAM loan 36 comprises a portion of the equity, and borrower 14 and a lender may share the appreciated portion of the equity. In some embodiments, loan calculation server 60 calculates a lender portion value associated with a lender portion of the equity appreciation, and a borrower portion value associated with a borrower portion of the equity appreciation. In some embodiments, the lender portion value and the borrower portion value may each represent 50% of the equity appreciation. However, in other embodiments, the lender portion value and the borrower portion value may comprise different relative percentages of the equity appreciation. In particular, the borrower portion value may be higher or lower than the lender portion value depending on an interest rate applied to SAM loan 36. As noted above, borrower 12 may pay a higher interest rate to obtain a higher borrower portion of the SAM loan 36, or may pay a lower interest to obtain lower borrower portion of SAM loan 36. Loan calculation server 60 stores information associated with SAM loan 36, including a SAM loan value, a borrower portion value, a lender portion value, and an interest rate applied to SAM loan 36 in original loan profile 32.

Loan calculation server 60 may additionally or alternatively calculate an estimated point in time at which property 14 will no longer be underwater. Loan calculation server 60 may receive market data 38 from market data server 40 indicating projected rates of property appreciation. Using the current value of property 14, loan calculation server calculates a certain percentage of gain or loss for property 14 each month or year for a successive predetermined number of months or years. For example, loan calculation server 60 may calculate a −3% appreciation in year 1, a −2% appreciation in year 2, a 5% appreciation in year 3, a 4% appreciation in year 4, etc. The cumulative appreciation over the predetermined number of months or years is compared against the decline in the aggregate of the conforming loan value and the SAM loan value at each respective month or year. In some embodiments, the conforming loan value declines over time because borrower 12 makes payments on conforming loan 35. By comparing an estimated future value of property 14 to the projected value of the aggregate of the conforming loan value and the SAM loan value, loan calculation server 60 may estimate a time at which property 14 will no longer be underwater. Loan calculation server 60 may store a projected time at which property 14 is expected to no longer be underwater in original loan profile 32.

Loan officer computer 70 is communicatively coupled to loan calculation server 60, receives input from loan officer 16, transmits a request to calculate a structure for conforming loan 35 and SAM loan 36, and displays results of calculations performed by loan calculation server 60. Loan officer 16 may be a person tasked with refinancing original loan 33, providing estimated conforming loan and SAM loan values for refinancing original loan 33, and/or providing information to borrower 12 on refinancing options for original loan 33. Loan officer computer 70 may include a graphical user interface (GUI) 78. GUI 78 is generally operable to tailor and filter data presented to loan officer 16. GUI 78 provides user with an efficient and user-friendly presentation of original loan profile 78, and refinanced loan profile 34, and/or other suitable information. GUI 78 comprises a plurality of displays having interactive fields, pull-down lists, and buttons operated by loan officer 16 and/or another user. In one example, GUI 78 presents original loan profile 32 and/or refinanced loan profile 34 to loan officer 16 and may provide input fields or button to enter relevant information used by loan calculation server 60 to calculate a conforming loan value and a SAM loan value. For example, loan officer 16 may input an interest rate(s) associated with conforming loan 35, an interest rate(s) associated with SAM loan 36, a number of years for which conforming loan 35 is amortized, a borrower portion of equity appreciation in property 14, a lender portion of equity appreciation in property 14, and/or any other relevant variables, data, and/or values used by loan calculation server. GUI 78 may include multiple levels of abstraction including groupings and boundaries. It should be understood that the term GUI 78 may be used in the singular or in the plural to describe one or more GUIs 78 and each of the displays of a particular GUI 78.

Loan officer computer 70 may comprise any suitable combination of hardware and/or software implemented in one or more modules to provide the described functions and operations. In some embodiments, loan officer computer 70 may comprise a general-purpose personal computer (PC), a Macintosh, a workstation, a Unix-based computer, a server computer, or any suitable processing device. In some embodiments, the functions and operations described above may be performed by a pool of multiple loan officer computers 70. A particular loan officer computer 70 may comprise memory 74 and processor 72.

Memory 74 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. Although FIG. 1 illustrates memory 74 as internal to loan officer computer 70, it should be understood that memory 74 may be internal or external to loan officer computer 70, depending on particular implementations. Also, memory 74 may be separate from or integral to other memory devices to achieve any suitable arrangement of memory devices for use in refinancing system 10.

Memory 74 is generally operable to store original loan profile 32, refinanced loan profile 34, borrower profile 30, property profile 37, relevant interest rates, amortization schedules, and/or any other values, parameters, functions, and/or attributes utilized by refinancing system 10. Memory 74 is further operable to store logic 76. Logic 76 generally comprises rules, algorithms, code, tables, and/or other suitable instructions for storing, processing, transmitting and/or generating information associated with original loan 33, conforming loan 35, and/or SAM loan 36.

Memory 74 is communicatively coupled to processor 72. Processor 72 is generally operable to execute logic 74 to receive input from loan officer 16, transmit received input to loan calculation server 60, and/or display results of calculations performed by loan calculation server 60 on GUI 78. Processor 72 comprises any suitable combination of hardware and software implemented in one or more modules to provide the described function or operation.

Borrower computer 80 receives input from borrower 12 and transmits relevant parameters and/or values to one or more other components of refinancing system 10. In particular embodiments, borrower computer 80 receives a request from borrower 12 to refinance original loan 33. Borrower 12 enters one or more values on an interface of borrower computer 80, including, but not limited to, an amount borrowed to purchase property 14, an amortization schedule associated with original loan 33, an interest rate(s) associated with original loan 33, a current value of original loan 33 (including the value of original loan 33 when it was originated, minus any principal and/or interest payments made, plus any accumulated interest), information indicating whether original loan 33 is performing or is in default, and/or any other relevant information associated with original loan 33, borrower's 12 income history, credit score, credit history, address information, the value of original loan 33 at the time original loan 33 was originated, an interest rate and/or interest rates associated with original loan 33, a down payment provided by borrower 12 in connection with original loan 33, and/or any other values utilized by refinancing system 10. In particular embodiments, borrower computer 80 may be communicatively coupled to one or more other components of refinancing system 10, including loan officer computer 70 and/or loan calculation server 60. Once borrower 12 inputs information associated with refinancing original loan 33, borrower computer 80 transmits the relevant information to loan calculation server 60 and/or loan officer computer 70. Loan calculation server 60 uses the received information to calculate a structure of conforming loan 35 and SAM loan 36.

As explained above, account server 20, market data server 40, loan calculation server 60, loan officer computer 70, and/or borrower computer 80 are communicatively coupled via one or more networks 50. Network 50 may represent any number and combination of wireline and/or wireless networks suitable for data transmission. Network 50 may, for example, communicate internet protocol packets, frame relay frames, asynchronous transfer mode cells, and/or other suitable information between network addresses. Network 50 may include one or more intranets, local area networks, metropolitan area networks, wide area networks, cellular networks, all or a portion of the Internet, and/or any other communication system or systems at one or more locations.

It should be understood that the internal structure of refinancing system 10 and the servers, processors, and memory devices associated therewith is malleable and can be readily changed, modified, rearranged, or reconfigured to achieve the intended operations of refinancing system 10.

In operation, loan calculation server 60 calculates a conforming loan value associated with conforming loan 35 and SAM loan value associated with SAM loan 36 in order to calculate a refinancing structure for original loan 33. As discussed above, borrower 12 owns property 14 which may have a current value less than a current value of original loan 33. Consequently, borrower 12 may wish to refinance original loan 33 so that property 14 does not enter foreclosure. To provide refinancing options, loan calculation server 60 may calculate conforming loan 35 and SAM loan 36.

In some embodiments, loan calculation server 60 receives a request to calculate a structure for conforming loan 35 and/or SAM loan 36 to refinance original loan 33. In some embodiments, loan calculation server 60 receives a request from loan officer computer 70 and/or borrower computer 80. Loan calculation server 60 transmits an electronic request to account server 20 requesting borrower profile 30 and/or original loan profile 32. As discussed above, borrower profile 30 is electronically stored on account server 20, and includes information associated with borrower 12 and/or original loan 33, including, but not limited to the borrower's income history, credit history, address information, the value of original loan 33 at the time the loan is originated, an interest rate and/or interest rates associated with original loan 33, a down payment provided by borrower 12 in connection with original loan 33, and/or any other relevant information used by a financial institute to originate, buy, sell, and/or otherwise process original loan 33. Loan calculation server 60 may transmit an electronic request by transmitting information included in a packet frame and/or cell over network 50.

Additionally or alternatively, loan calculation server 60 transmits an electronic request to market data server 40 requesting property profile 37 from market data server 40. In general, however, loan calculation server 60 requests original loan profile 32, borrower profile 30, and/or property profile 37 in any appropriate manner suitable to perform the described functionality.

Once original loan profile 32, borrower profile 30, and/or property profile 37 are received, loan calculation server 60 may calculate a conforming loan value associated with conforming loan 35 and SAM loan value associated with SAM loan 36 to provide refinancing information to loan officer 16. As discussed above, loan calculation server 60 calculates a conforming loan value associated with a conforming loan 35 and a SAM loan value associated with SAM loan 36. Loan calculation server 60 calculates a conforming loan value, and a SAM loan value based on a current property value indicated in property profile 37 and a current value of original loan 33. The conforming loan value may be based on the current value of property 14. As discussed above, the conforming loan value may be a predetermined percentage of the current value of property 14. Loan calculation server 60 may store a conforming loan value associated with conforming loan 35 in refinanced loan profile 34.

The SAM loan value may be based on a difference between a current value of original loan 33 and the conforming loan value. Additionally or alternatively, loan calculation server 60 calculates a lender portion and a borrower portion of equity appreciation in property 14. In some embodiments, the lender portion and the borrower portion each represent 50% of the equity appreciation. However, in other embodiments, the lender portion and the borrower portion comprise different relative percentages. Specifically, the borrower portion may be higher or lower than the lender portion depending on an interest rate(s) associated with SAM loan 36. As noted above, borrower 12 may pay a higher interest rate to obtain a higher borrower portion, or may pay a lower interest to obtain lower borrower portion. Loan calculation server 60 may store information associated with SAM loan 36, including respective borrower portions and lender portions, and an interest rate(s) associated with SAM loan 36 in refinanced loan profile 34.

Additionally or alternatively, loan calculation server 60 calculates an estimated time at which property 14 will no longer be underwater. In particular, loan calculation server 60 receives information from market data server 40 indicating amounts of property appreciation for each one or more successive years or months. Using the current value of property 14, loan calculation server applies a certain percentage of appreciation or depreciation for each successive year or month for a predetermined number of years or months. Loan calculation server 60 compares the cumulative appreciation over the predetermined number of years or months against the value of conforming loan 35 and SAM loan 36 in each respective year and/or month (in particular embodiments, the value of the conforming loan declines because borrower 12 makes payments on the first loan). By comparing an estimated value of property 14 to the estimated value of the aggregate of conforming loan 35 and SAM loan 36, loan calculation server 60 determines a time at which property 14 is expected to no longer be underwater. In some embodiments, loan calculation server 60 stores a time at which property 14 is expected to no longer be underwater in refinanced loan profile 34.

Loan calculation server 60 transmits original loan profile 32, and refinanced loan profile 34 to loan officer computer 70. Loan officer computer 70 uses information included in original loan profile 32 and/or refinanced loan profile 34 to generate a display on GUI 78. As discussed above, GUI 78 displays a conforming loan value associated with conforming loan 35, an amortization schedule of the conforming loan, an interest rate(s) associated with the conforming loan, and/or a value of conforming loan 35 over time. GUI 78 also displays information associated with SAM loan 36 and/or shared equity in property 14, including a respective borrower portion and/or lender portion over time, and an interest rate(s) associated with the SAM loan. By displaying an intersection of the estimated future values of property 14 with the values of the aggregate of conforming loan 35 and SAM loan 36, GUI 78 may display a time at which property 14 is expected to no longer be underwater.

Prior to or subsequent to an initial calculation of a conforming loan value and a SAM loan value, loan officer 16 may input information relevant to the calculation of the conforming loan value and/or the SAM loan value. For example, loan officer 16 may enter an interest rate associated with conforming loan 35 and/or SAM loan 36, a respective borrower and lender portions of SAM loan 36, a current value of property 14, estimated future values of property 14, the current value of original loan 33, and/or any other variables, inputs, factors, or values relevant to the calculation of conforming loan 35 and SAM loan 36 based on an underwater original loan 33. Inputting one or more values may allow loan officer 16 to dynamically update the values associated with conforming loan 35, SAM loan 36, the respective borrower and lender portions of SAM loan 36, and/or any other information associated with the refinancing of original loan 33.

Based on the foregoing operations, a financial institution is able to refinance original loan 33. A lending institution originates conforming loan 35, a government or other financial entity provides funds for the lender portion of SAM loan, and borrower 12 receives equity for the borrower portion of shared equity in the event that the aggregate of conforming loan 35 and SAM loan 36 is greater than a future value of property 14. Thus, by providing for refinancing of an underwater mortgage and/or property, a borrower of original loan is able to reduce the value of mortgage payments, while preventing foreclosure.

Modifications, additions, or omissions may be made to refinancing system 10 without departing from the scope of the invention. For example, when a component of refinancing system 10 determines information, the component may determine the information locally or may receive the information from a remote location. As another example, in the illustrated embodiment, loan calculation server 60, market data server 40, account server 20, loan officer computer 70, and borrower computer 80 are represented as different components of refinancing system 10. However, the functions of loan calculation server 60, market data server 40, account server 20, loan officer computer 70, and/or borrower computer 80 may be performed by any suitable combination of one or more servers or other components at one or more locations. In the embodiment where the various components are servers, the servers may be public or private servers, and each server may be a virtual or physical server. The server may include one or more servers at the same or at remote locations. Also, loan calculation server 60, market data server 40, account server 20, and loan officer computer 70 may include any suitable component that functions as a server. Additionally, refinancing system 10 may include any number of loan calculation servers 60, market data servers 40, account servers 20, loan officer computers 70 and/or borrower computers 80. Any suitable logic may perform the functions of refinancing system 10 and the components within refinancing system 10.

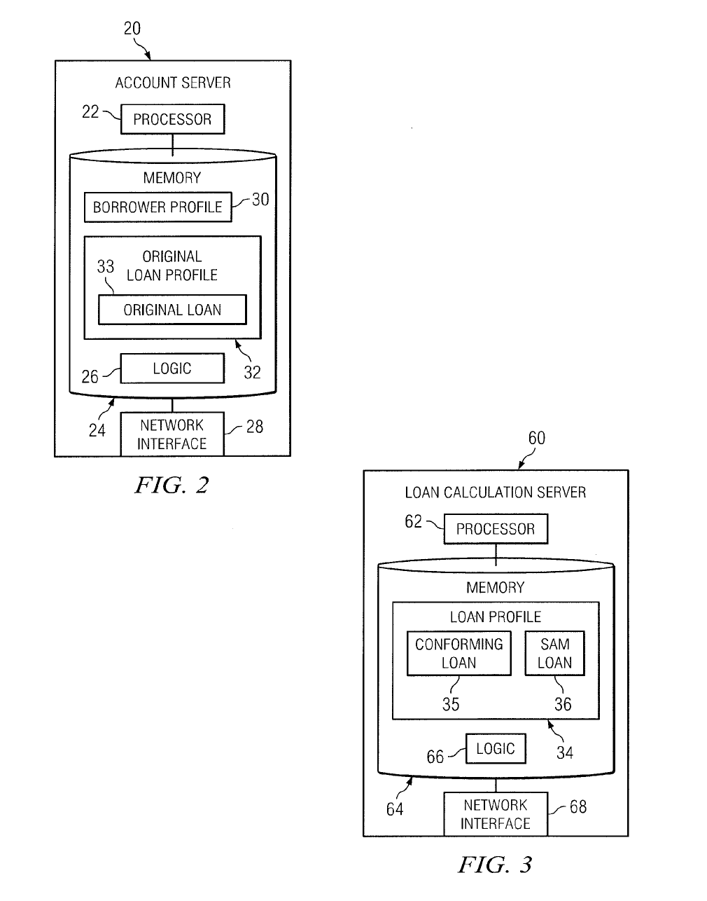

FIG. 2 represents a block diagram illustrating aspects of the account server 20 discussed above with respect to FIG. 1. As discussed above, account server 20 stores borrower profile 30, and original loan profile 32 and communicatively couples to loan calculation server 60 over network 50. Account server 20 transmits borrower profile 30 and/or original loan profile 32 over network 50 to loan calculation server 60 in response to a request from loan calculation server 60. In some embodiments, account server 20 transmits borrower profile 30 and/or original loan profile 32 to loan calculation server 60 in response to a request from borrower computer 80 and/or loan officer computer 70 for information included in borrower profile 30 and/or original loan profile 32.

Account server 20 comprises any suitable combination of hardware and/or software implemented in one or more modules to provide the described functions and operations. In some embodiments, account server 20 may comprise a general-purpose personal computer (PC), a Macintosh, a workstation, a Unix-based computer, a server computer, or any suitable processing device. In some embodiments, the functions and operations described above may be performed by a pool of multiple account servers 40. A particular account server 20 may comprise a memory 24 and processor 22.

Memory 24 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information such as borrower profile 30 and original loan profile 32. Although FIG. 2 illustrates memory 24 as internal to account server 20, it should be understood that memory 24 may be internal or external to account server 20, depending on particular implementations. Memory 24 may be separate from or integral to other memory devices to achieve any suitable arrangement of memory devices for use in refinancing system 10.

Memory 24 is generally operable to store borrower profile 30 and original loan profile 32. A particular borrower profile 30 represents information pertaining to borrower 12 associated with original loan 33. Borrower profile 30 may include information associated with the borrower 12 and/or original loan 33, including, but not limited to borrower's 12 income history, credit history, address information, the value of original loan 33 at the time the original loan 33 is originated, an interest rate and/or interest rates associated with original loan 33, a down payment provided by borrower 12 to purchase property 14, and/or any other relevant information used by a financial institution to originate, buy, sell, and/or otherwise process original loan 33. Memory 24 is further operable to store logic 26. Logic 26 generally comprises rules, algorithms, code, tables, and/or other suitable instructions for storing and/or generating borrower profile 30, original loan profile 32, and/or any other appropriate information.

Memory 24 is communicatively coupled to processor 22. Processor 22 is generally operable to execute logic 26 to receive requests for information associated with borrower 12, information associated with original loan 33 generate, store borrower profile 30 and/or original loan profile 32 in memory 24, retrieve borrower profile 30 and/or original loan profile 32 from memory 24, and/or transmit borrower profile 30 and/or original loan profile 32 to loan calculation server 60. Processor 22 comprises any suitable combination of hardware and software implemented in one or more modules to provide the described function or operation.

Network interface 28 communicates information with network 50. For example, network interface 28 receives a request for borrower and/or original loan information from borrower computer 80, loan officer computer 70, and/or borrower computer 80 through network 50. As another example, network interface 28 communicates borrower profile 30 and/or original loan profile 32 to loan calculation server 60. Network interface 28 represents any port or connection, real or virtual, including any suitable hardware and/or software that allow account server 20 to exchange information with network 50, loan calculation server 60, loan officer computer 70, borrower computer 80, and/or or other components of refinancing system 10.

FIG. 3 represents a block diagram illustrating aspects of loan calculation server 60 discussed above with respect to FIG. 1. In general, loan calculation server 60 calculates a structure of conforming loan 35 and SAM loan 36 based on a current value of original loan 33 and a current value of property 14. As discussed above, loan calculation server 60 may calculate a conforming loan value associated with conforming loan 35 and a SAM loan value associated with SAM loan 36 based on a property valuation indicated in property profile 37 and a current value of original loan 33. The conforming loan value may be based, at least in part, on the current value of property 14. As discussed above, the conforming loan value may be a predetermined percentage of the current value of property 14. Once loan calculation server 60 calculates a conforming loan value, loan calculation server 60 stores the conforming loan value in refinanced loan profile 34. In some embodiments, after calculating a conforming loan value associated with conforming loan 35 and/or a SAM loan value associated with SAM loan 36, loan calculation server 60 transmits a conforming loan value and a SAM loan value to loan officer computer 70. Additionally or alternatively, loan officer computer 70 transmits refinanced loan profile 34, original loan profile 32, and/or any other values, parameters, or calculations utilized by loan calculation server 60 to loan officer computer 70. Local calculation server 60 includes memory 64, processor 62, and network interface 68.

Memory 64 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information such as original loan profile 32, borrower profile 30, property profile 37, refinanced loan profile 34, and/or any other relevant values, characteristics or variables utilized by refinancing system 10. Although FIG. 3 illustrates memory 64 as internal to loan calculation server 60, it should be understood that memory 64 may be internal or external to loan calculation server 60, depending on particular implementations. Also, memory 64 may be separate from or integral to other memory devices to achieve any suitable arrangement of memory devices for use in investing system 10.

Although FIG. 3 illustrates an embodiment of loan calculation server 60 storing refinanced loan profile 34, in some embodiments, memory 64 additionally or alternatively stores original loan profile 32, borrower profile 30, property profile 37, and logic 66. A particular refinanced loan profile 34 represents one or more characteristics of conforming loan 35 and/or SAM loan 36 calculated by loan calculation server 60. For example, refinanced loan profile 34 may include a conforming loan value, an interest rate(s) associated with conforming loan 35, and an amortization schedule of conforming loan 35. Refinanced loan profile 34 also includes one or more characteristics of SAM loan 36 calculated by loan calculation server 60, including a SAM loan value, a borrower portion of equity appreciation, and a lender portion of equity appreciation. Refinanced loan profile 34 may also include an interest rate(s) associated with SAM loan 36. Refinanced loan profile 34 may also include property appreciation and/or depreciation estimates, and an estimated time at which property 14 is expected to be no longer underwater.

Memory 64 stores logic 66. Logic 66 generally comprises rules, algorithms, code, tables, and/or other suitable instructions for performing the described functions and operations.

Memory 64 is communicatively coupled to processor 62. Processor 62 is generally operable to execute logic 66 stored in memory 64 to calculate a structure of conforming loan 35 and SAM loan 36 based on original loan profile 32, borrower profile 30, and/or property profile 37. Processor 62 may comprise any suitable combination of hardware and software implemented in one or more modules to provide the described function or operation.

Network interface 68 communicates information with network 50. For example, network interface 68 transmits a request for borrower and/or original loan information to account server 20 and/or market data server 40 through network 50. As another example, network interface 68 receives borrower profile 30 and/or original loan profile 32 through network 50. In particular embodiments, network interface 68 receives market data 38 from market data server 40 over network 50. Network interface 68 represents any port or connection, real or virtual, including any suitable hardware and/or software that allows loan calculation server 60 to exchange information with network 50, account server 20, market data server 40, loan officer computer 70, borrower computer 80, and/or or other components of refinancing system 10.

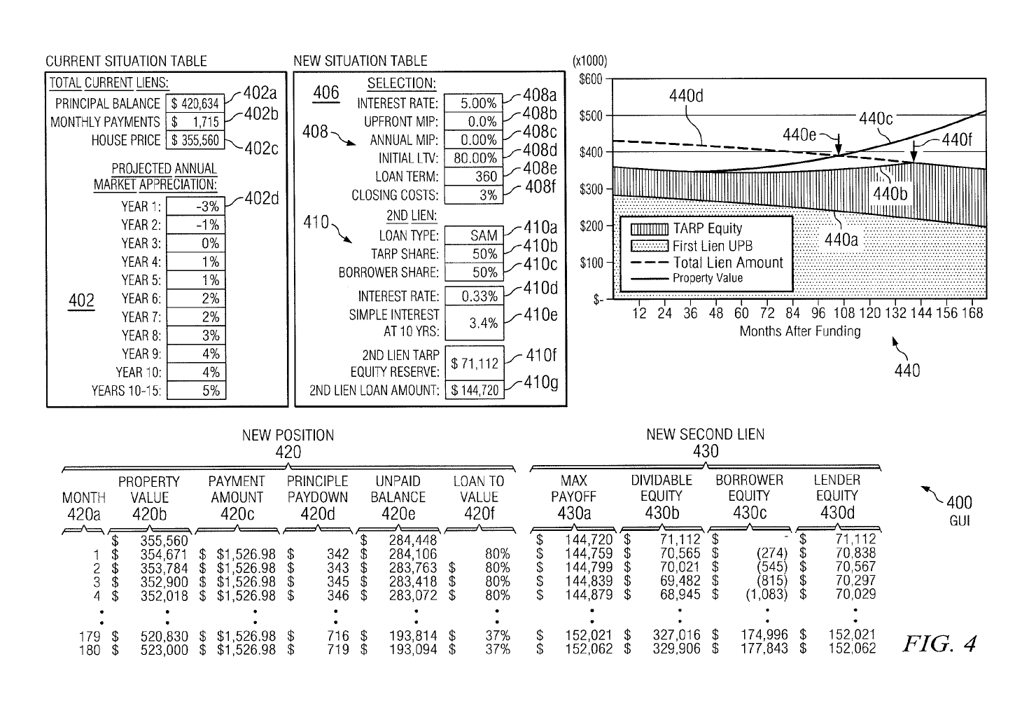

FIG. 4 illustrates an example GUI 400 that assists loan officer 16 in requesting and receiving refinancing models for original loan 33, according to certain embodiments. Loan officer computer 70 may display GUI 400 to loan officer 16 or another user. By interacting with GUI 400, loan officer 16 may request refinancing values for original loan 33, including a conforming loan value associated with conforming loan 35, and a SAM loan value associated with SAM loan 36, and may view results of calculations performed by loan calculation server 60.

In some embodiments, GUI 400 includes current situation table 402 and new situation table 408. Current situation table 402 includes information associated with original loan 33 and property 14. For example, current situation table 402 includes principal balance field 402a, which displays the current value of original loan 33, monthly payment field 402b, which displays the amount of combined principal and interest borrower 12 pays on original loan 33, and house price field 402c, which displays the current value of property 14. Current situation table 402 also includes market appreciation table 402d, which includes estimated market appreciation or depreciation for property 14 for a predetermined number of years. As shown in GUI 400, market appreciation table 404 displays estimated market appreciation for each of the first ten years, and an estimated appreciation for years 11-15.

New situation table 406 includes conforming loan parameters table 408 and SAM loan parameters table 410. Conforming loan parameters table 408 includes: (1) interest rate field 408a, which displays an amount of interest associated with conforming loan 35; (2) upfront MIP field 408b, which displays an amount of mortgage insurance premium to be applied when original loan 33 is refinanced; (3) annual MIP 408c, which displays an amount of mortgage insurance premium to be applied annually; (4) initial LTV field 408d, which displays the ratio of the conforming loan to the current value of property 14; (5) loan term field 408e, which displays the length of time, specified in months, conforming loan 35 will take to be repaid; (6) closing costs field 408f, which displays any closing costs associated with refinancing original loan 33.

SAM loan parameters table 410 includes: (1) loan type field 410a, which displays the type of loan SAM loan 36 represents; (2) lender portion field 410b, which displays a lender portion value, in percentage or absolute value terms, associated with a lender portion of SAM loan 36; (3) borrower portion field 410c, which displays a borrower portion value, in percentage or absolute value terms, associated with a borrower portion of equity appreciation; (4) interest rate field 410d, which displays an interest rate associated with SAM loan 36; (5) cumulative interest field 410e, which displays the cumulative simple interest rate at a predetermined year (e.g., 10 years); (6) lender portion 410f, which displays a lender portion value associated with a lender portion of equity appreciation in dollars; (7) SAM loan value field 410g, which displays the value of SAM loan 36 (e.g., original loan minus the conforming loan, plus any closing costs and mortgage insurance premium).

In particular embodiments, the values displayed in each of the fields comprising current situation table 402 and new situation table 406 are populated by loan calculation server 60 from information included in property profile 37, borrower profile 30, and/or market data 38. In some embodiments however, loan officer 16 may enter information into one or more relevant fields, thus altering the calculations performed by loan calculation server 60. In particular embodiments, one or more particular fields automatically update in response to inputs entered into other one or more particular fields by loan officer 16. For example, loan officer 16 may enter an interest rate in interest rate field 410d to change the amortization schedule of conforming loan 35. Entering a value in interest rate field 410d may determine, as one example, the values in payment amount column 402b, principle paydown column 420c, and unpaid balance column 420e of conforming loan amortization table 420. Loan officer 16 may also enter, as another example, values in lender portion field 410b and borrower portion field 410c. Entering a value in lender portion field 410b and/or borrower portion field 410c may determine the values in borrower equity column 430c and lender equity column 430d.

In some embodiments, GUI 400 also includes conforming loan amortization table 420, which displays one or more columns of information associated the conforming loan. In particular embodiments, conforming loan amortization table 420 includes month column 420a, which displays the successive repayment months associated with the conforming loan. Conforming loan amortization table 420 also includes property value column 420b, which displays the current value of property 14 for each month in month column 420a. Each value displayed in property value column 420b may be based, at least in part, on market data 38. Conforming loan amortization table 420 also includes payment amount column 420c, which displays the total amount of principal and interest borrower 12 pays on conforming loan 35 for each month in which conforming loan 35 is in repayment. Principal paydown column 420d displays the portion of the corresponding value in payment amount column 420c attributable to principle reduction for each month in which conforming loan 35 is in repayment. Unpaid balance column 420e displays the amount unpaid on conforming loan 35 for each month in which conforming loan 35 is in repayment. Loan-to-value column 420f displays the ratio between the value displayed in the corresponding row of unpaid balance column 420e to the value displayed in the corresponding property value column 420b, reflects the ratio of the current value of the conforming loan to the current value of property 14.

In some embodiments, GUI 400 also includes SAM loan table 430, which displays one or more columns of information associated the SAM loan. In some embodiments, SAM loan table 430 includes max payoff column 430a, which displays a value of SAM loan 36 for each month in with the conforming loan is in repayment. Each row in max payoff column 430a represents an unpaid balance of SAM loan 36 plus accumulated simple interest at a rate shown in interest rate field 410d. SAM loan table 430 also includes dividable equity column 430b, which represents the value specified in a corresponding row property value column 420b of conforming loan table 420 minus the value specified in a corresponding row of unpaid balance column 420e of conforming loan table 420. The value specified in dividable equity represents the total current equity in property 14. SAM loan table 430 also includes borrower equity 430c, which represents the borrower portion of the value specified in a corresponding row of dividable equity column 430b. SAM loan table 430 also includes lender equity column 430d, which represents the lender portion of the value specified in a corresponding row of dividable equity column 430b. In particular embodiments, the value displayed in lender equity column 430d is limited to the SAM loan 36 value plus any accumulated interest at a rate displayed in interest rate field 410d.

In some embodiments, GUI 400 also includes chart 440, which graphically illustrates the values specified in one or more tables illustrated in GUI 400. The horizontal axis of chart 400 represents the number of months subsequent to refinancing original loan 33. The vertical axis represents an amount in dollars for each of the four line values shown. For example, chart 440 includes conforming loan line 440a, which represents the values in unpaid balance column 420e of conforming loan amortization table 420. As shown in chart 420, as borrower 12 pays off portions of the conforming loan over time, conforming loan line 440a decreases. Chart 440 also includes lender equity line 440b, which represents the values in lender equity column 430d. Chart 440 also includes property value line 440c, which represents the property values specified in property value column 420b. Chart 440 also includes total loan amount line 440d, which represents the total value of conforming loan 35 and SAM loan 36 over time. In particular embodiments, a time at which various entities positions become positive may also be marked with an indicator. For example, as shown by indicator 440e in the illustrated example, the borrower's equity portion becomes positive in month 106 (i.e., the current value of property 14 is greater than the total of the current value of conforming loan 35 and SAM loan 36). As shown by indicator 440f in the illustrated example, the lender's equity portion becomes positive in month 139 (i.e., the month at which the lender portion reaches its maximum amount of value of SAM loan 36, plus accumulated interest). As can be seen graphically in chart 440, if, in this example, borrower 12 sells property 14 prior to the 106th month, borrower 12 would owe the refinancing lending institution for the sum of the current value of conforming loan 35 and SAM loan 36, minus the current value of property 14. If borrower 12 sells property 14 after the 106th month, borrower 12 receives surplus equity.

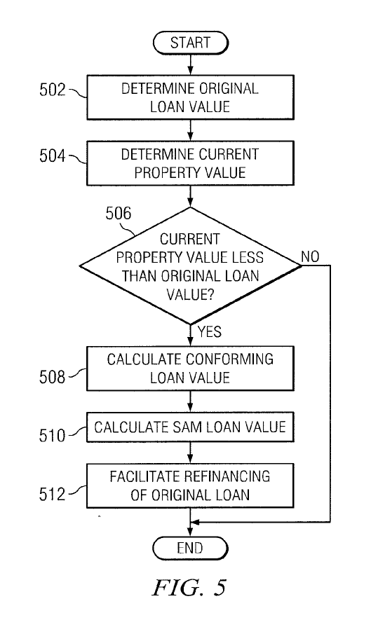

FIG. 5 is a flow diagram illustrating an operation in accordance with a particular embodiment of refinancing system 10. In the illustrated example, operation begins at step 502 with a current value of original loan 33 being determined. As discussed above, borrower 12 may borrow original loan 33 to purchase property 14. A lending institution carries a mortgage on property 14 to secure repayment of original loan 33. A current value of original loan 33 represents the value of original loan 33 at the time original loan 33 was originated, plus any accumulated interest, minus any principle and/or interest payments paid by borrower 12. Loan calculation server 60 may determine an original loan 33 value from information included in borrower profile 30, original loan profile 32 and/or any other appropriate information source.

At step 504, refinancing system 10 determines a current value of property 14. Loan calculation server 60 may determine a current value of property 14 from information included in property profile 37, from market data 38 received from market data server 40 and/or any other appropriate information source.

At step 506 refinancing system 10 determines whether the current value of property 14 is less than the current value of original loan 33. Subsequent to the purchase of property 14, property 14 may be valued at an amount less than the current value of original loan 33. If the current value of property 14 is less than the current value of original loan 33, operation continues at step 508. Otherwise, operation terminates.

At step 508, a conforming loan value is calculated based, at least in part, on the current property value, wherein the conforming loan value is associated with a conforming loan and the conforming loan value is less than the current property value. In particular embodiments of refinancing system 10, original loan 33 is refinanced into conforming loan 35 and SAM loan 36. Loan calculation server 60 calculates a value of conforming loan 35 based on the current value of property 14. The value of conforming loan 35 is based on a predetermined percentage of the current value of property 14. For example, in particular embodiments, the conforming loan value may be 80% of the current value of property 14.

At step 510, a SAM loan value is calculated based on a numerical difference between the conforming loan value and the SAM loan value. In particular embodiments, the SAM loan value is associated with SAM loan 36, and payments are not due on SAM loan 36 unless a title associated with the property is conveyed and the SAM loan value becomes due upon conveyance of the title associated with the property. As discussed above, in particular embodiments, SAM loan 36 represents a portion of original loan 33 refinanced as equity that is shared between borrower 12 and a lender. In some embodiments, a lending institution, such as, for example, the United States Government, provides funds for a lender portion of SAM loan 36. In some embodiments of refinancing system 10, the lender and borrower portions of equity appreciation are equal. However, as discussed above, the relative amount of the lender and borrower portion may be based on an interest rate applied to SAM loan 36. Since SAM loan 36 represents an equity portion of the refinanced amounts, no payments are due, unless borrower 12 conveys property 14. Upon such a conveyance, the current SAM loan value and the current conforming loan value would be due immediately. If borrower 12 sold property 14 for less than the aggregate of the then-current conforming loan value and the then-current SAM loan value, borrower 12 would owe the lending institution for the difference between the selling price and the then-current conforming loan value and the then-current SAM loan value.

At step 512, refinancing system 10 facilitates the refinancing of original loan 33. A refinanced loan includes conforming loan 35 and SAM loan 36. Loan calculation server 60 stores a value associated with conforming loan 35 and a value associated with SAM loan 36 in refinanced loan profile 34. In some embodiments, loan calculation server 60 transmits one or more values associated with conforming loan 35 and SAM 36 to loan officer computer 70. Loan officer computer 70 displays a graphical representation of values associated with conforming loan 35 and SAM loan 36 on GUI 78. By interacting with loan officer computer 70 and/or GUI 78, loan officer 16 is able to facilitate a refinancing of original loan 33.

The steps illustrated in FIG. 5 may be combined, modified, or deleted where appropriate, and additional steps may also be added to those shown. Additionally, the steps may be performed in any suitable order without departing from the scope of the present disclosure.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method for refinancing a loan comprising:
determining an original loan value, wherein the original loan value is associated with an original loan secured by a property having a current property value that is less than the original loan value;
calculating, with a processor, a conforming loan value based, at least in part, on the current property value, wherein the conforming loan value is associated with a conforming loan and the conforming loan value is less than the current property value; and
calculating a shared appreciation mortgage (“SAM”) loan value based on a numerical difference between the conforming loan value and the original loan value, wherein the SAM loan value is associated with a SAM loan, and payments are not due on the SAM loan unless a title associated with the property is conveyed and the SAM loan value becomes due upon conveyance of the title associated with the property.

2. The method of claim 1, wherein calculating a SAM loan value comprises calculating a lender portion of equity appreciation in the property and a borrower portion of equity appreciation in the property.

3. The method of claim 2, wherein the lender portion and the borrower portion are equal.

4. The method of claim 1, further comprising receiving market data, wherein the market data includes expected appreciation of the property each year for a predetermined number of years.

5. The method of claim 4, further comprising calculating, based, at least in part, on the market data, a future time at which a property value associated with the property at the future time will be greater than the sum of a value of the conforming loan at the future time and a value of the SAM loan at the future time.

6. A system for refinancing a loan comprising:
a loan calculation server operable to:
determine an original loan value, wherein the original loan value is associated with an original loan secured by a property having a current property value that is less than the original loan value;
calculate a conforming loan value based, at least in part, on the current property value, wherein the conforming loan value is associated with a conforming loan and the conforming loan value is less than the current property value; and
calculate a shared appreciation mortgage (SAM) loan value based on a numerical difference between the conforming loan value and the original loan value, wherein the SAM loan value is associated with a SAM loan, and payments are not due on the SAM loan unless a title associated with the property is conveyed and the SAM loan value becomes due upon conveyance of the title associated with the property; and
a loan officer computer operable to:
transmit, to the loan officer computer, a lender portion value associated with a lender portion of equity appreciation in the property and a borrower portion value associated with a borrower portion of equity appreciation in the property;
receive the conforming loan value and the SAM loan value from the loan calculation server; and
display the conforming loan value and the SAM loan value on a graphical user interface associated with the loan officer computer.

7. The system of claim 6, wherein the loan calculation server is operable to calculate a SAM loan value by calculating the lender portion of equity appreciation in the property and the borrower portion of the equity appreciation in the property.

8. The system of claim 7, wherein the lender portion and the borrower portion are equal.

9. The system of claim 6, wherein the loan calculation server is further operable to receive market data, wherein the market data includes expected appreciation of the property each year for a predetermined number of years.

10. The system of claim 9, wherein the loan calculation server is further operable to calculate, based, at least in part, on the market data, a future time at which a property value associated with the property at the future time will be greater than the sum of a value of the conforming loan at the future time and a value of the SAM loan at the future time.

11. An apparatus for refinancing a loan, wherein the apparatus is operable to:
determine an original loan value, wherein the original loan value is associated with an original loan secured by a property having a current property value that is less than the original loan value;
calculate a conforming loan value based, at least in part, on the current property value, wherein the conforming loan value is associated with a conforming loan and the conforming loan value is less than the current property value; and
calculate a shared appreciation mortgage (SAM) loan value based on a numerical difference between the conforming loan value and the original loan value, wherein the SAM loan value is associated with a SAM loan, and payments are not due on the SAM loan unless a title associated with the property is conveyed and the SAM loan value becomes due upon conveyance of the title associated with the property.

12. The apparatus of claim 11, wherein the apparatus is operable to calculate a SAM loan value by calculating a lender portion of equity appreciation in the property and a borrower portion of equity appreciation in the property.

13. The apparatus of claim 12, wherein the lender portion and the borrower portion are equal.

14. The apparatus of claim 11, wherein the apparatus is further operable to receive market data, wherein the market data includes expected appreciation of the property each year for a predetermined number of years.

15. The apparatus of claim 14, wherein the apparatus is further operable to calculate, based at least in part, on the market data, a future time at which a property value associated with the property at the future time will be greater than the sum of a value of the conforming loan at the future time and a value of the SAM loan at the future time.

16. A computer readable storage medium comprising logic, the logic operable, when executed on a processor, to:
determine an original loan value, wherein the original loan value is associated with an original loan secured by a property having a current property value that is less than the original loan value;
calculate a conforming loan value based, at least in part, on the current property value, wherein the conforming loan value is associated with a conforming loan and the conforming loan value is less than the current property value; and
calculate a shared appreciation mortgage (SAM) loan value based on a numerical difference between the conforming loan value and the original loan value, wherein the SAM loan value is associated with a SAM loan, and payments are not due on the SAM loan unless a title associated with the property is conveyed and the SAM loan value becomes due upon conveyance of the title associated with the property.

17. The computer readable storage medium of claim 16, wherein the logic is operable to calculate a SAM loan value by calculating the lender portion of equity appreciation in the property and the borrower portion of equity appreciation in the property.

18. The computer readable storage medium of claim 17, wherein the lender portion and the borrower portion are equal.

19. The computer readable storage medium of claim 16, wherein the logic is further operable to receive market data, wherein the market data includes expected appreciation of the property each year for a predetermined number of years.

20. The computer readable storage medium of claim 16, wherein the logic is further operable to calculate, based, at least in part, on the market data, a future time at which a property value associated with the property at the future time will be greater than the sum of a value of the conforming loan at the future time and a value of the SAM loan at the future time.
